(19) United States
(12) Patent Application Publication
(10) Pub. No.: US 2010/0268399 A1
(43) Pub. Date: Oct. 21, 2010

(54) METHOD FOR OPERATING AIR MATTRESS CONTROLLER AND STRUCTURE THEREOF

(76) Inventors: CHEN-HUNG TSAI, Xin Tien City (TW); YI-CHEN LU, Xin Tien City (TW); YI-LING LIU, Xin Tien City (TW)

Correspondence Address: LEONG C LEI, PMB # 1008, 1867 YGNACIO VALLEY ROAD, WALNUT CREEK, CA, 94598, US

(21) Appl. No.: 12/423,823

(22) Filed: Apr. 15, 2009

(51) Int. Cl. G05D 16/20

(52) U.S. Cl. 700/301

(57) ABSTRACT

A method for regulating air mattress pressure includes setting an initial first pressure; maintaining the first pressure stable with respect to an air mattress; setting a subsequent second pressure, wherein the second pressure is smaller than the first pressure; maintaining the second pressure stable with respect to the air mattress; computing a time interval for transferring from the first pressure to a stable condition of the second pressure; determining load and optimum pressure level of the air mattress through a database on the basis of the time interval; and charging air into the air mattress to the optimum pressure.

### TECHNICAL FIELD OF THE INVENTION

The present invention relates generally to a method for operating an air mattress pressure controller and a structure thereof, and particularly to a low cost regulation method for efficiently adjusting parameters for effecting air charging for an air mattress and an air mattress pressure controller constructed on the basis of the method.

### DESCRIPTION OF THE PRIOR ART

An air mattress provides a comfortable support for sitting and lying and is widely used in medicine-related applications, in particular in caring old people, spine-damaged people, brainstem-damaged people (vegetables), paralysis patients, and severe dementia patients, for being good in preventing the occurrence of bedsores, and further, an air mattress featuring automatic pressure regulation is useful in reducing the pain resulting from skin damages caused by body weights for those patients who are able to turn their bodies on the beds due to impaired motion function caused by external injury or wound, such as burning, or caused by rare diseases or injuries and is also good in soothing the pain caused by improper postures.

The air mattress is now widely used by various users, who may have different body sizes and weight, as well as different genders and ages. Different users of different body characteristics can bear different pressures built in the air mattresses. Thus, it is an important issue to be addressed how to properly operating a controller of an air mattress in order to properly inflate the air mattress to suit the needs of different users.

The conventional design of the air mattress is to use a pump, which is operated under a predetermined air pressure, to continuously charge air into the air mattress for inflation. The air mattress, which is often designed for a rated pressure, allows an excessive pressure to release through a valve when subjected to a load, such as a user lying on the air mattress. However, such a rated pressure is only an empirical average and cannot provide a comfortable inflation of the air mattress for various patients. A manual controller that controls the air pump is available in the market to allow medical personnel to manually adjust air inflow and thus the internal pressure of the air mattress after consulting the patients lying on the air mattress. However, it is often that the patient lying on the air mattress bed is not able to provide his or her actual feeling about the mattress pressure and the observation of the attendant medical personnel may sometimes be insufficiently objective, so that adjusting the air mattress pressure in this way is still not good enough.

Electronic controllers are later available in the market. Patient's data, such as height, weight, age, and disease, are entered into the electronic controller and a corresponding air pressure is retrieved from a database to control and operate an air pump for inflating the air mattress by providing a corresponding and best air inflow. The electronic controller is a delicate and sophisticated device, and is thus expensive and easy to damage. This makes the electronic controller not available in small-size medical facility and may not be fully available even in large-sized medical facilities. Thus, it is desired to provide a low-cost automatic air mattress controller to make comfortable applications of air mattress available widely for benefiting people of different needs.

### SUMMARY OF THE INVENTION

An objective of the present invention is to provide a method for regulating air mattress pressure, comprising setting an initial first pressure; maintaining the first pressure stable with respect to an air mattress; setting a subsequent second pressure, wherein the second pressure is smaller than the first pressure; maintaining the second pressure stable with respect to the air mattress; computing a time interval for transferring from the first pressure to a stable condition of the second pressure; determining load and optimum pressure level of the air mattress through a database on the basis of the time interval; and charging air into the air mattress to the optimum pressure.

The present invention offers the advantages of being more precise than manual operation, of lower costs than the conventional high-precision equipments that are expensive, and being easy to operate.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flow chart illustrating a method for controlling air mattress pressure in accordance with the present invention.

FIG. 2 illustrates a pressure-time curve that features the method in accordance with the present invention in controlling the air mattress pressure.

FIG. 3 is block diagram illustrating an air mattress pressure controller in accordance with the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

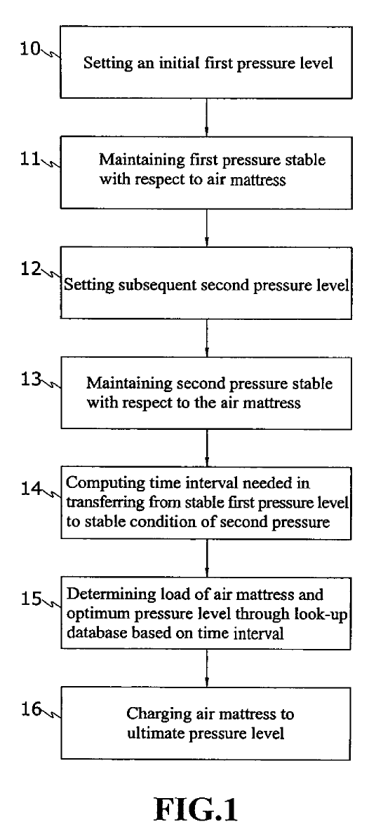

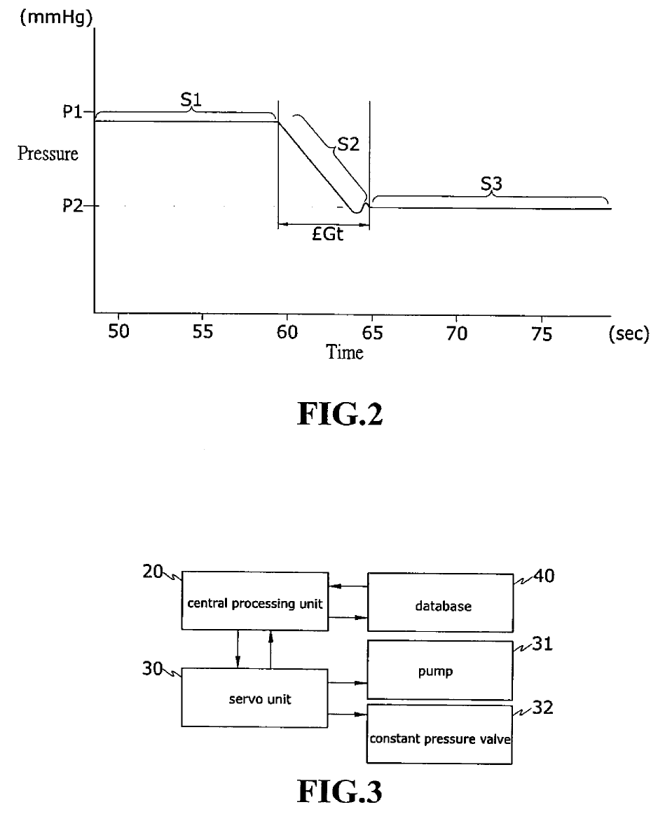

With reference to the drawings and in particular to FIGS. 1 and 2, a method for operating an air mattress controller in accordance with the present invention comprises the following steps:

(1) Setting an initial first pressure level (step 10): At first, a predetermined pressure level is provided, which is a proper pressure level based on a loaded condition of an air mattress (namely a person being carried on the air mattress), such as a first pressure P1 shown in FIG. 2.

(2) Maintaining first pressure stable with respect to air mattress (step 11): Maintaining the first pressure of the air mattress stable and fixed is achieved by means of operation and regulation of an air pump and a constant pressure valve, whereby a line segment (S1) of FIG. 2 that indicates a stable condition associated with this maintenance of air mattress pressure is obtained.

(3) Setting subsequent second pressure level (step 12): The second pressure level (P2) is lower than the first pressure level (P1).

(4) Maintaining second pressure stable with respect to the air mattress (step 13): The air mattress pressure is maintained stable and constant as indicated by line segment (S3) of FIG. 2.

(5) Computing time interval needed in transferring from stable first pressure level to stable condition of second pressure (step 14): The time interval can be for example seconds, of which an illustrative example is shown in FIG. 2 wherein the time interval (Δt) for the air mattress changing from the stable first pressure (P1) to the lower second pressure (P2) and becoming stable (equilibrium) is several seconds. This is indicated by an inclined line segment (S2) of FIG. 2. For a short time interval (Δt), the inclined line segment (S2) approaches a vertical lines (namely steep), meaning the load applied to the air mattress (such as the body weight of a patient lying on the air mattress) is heavy; otherwise the load is light. This information is applied to determine the optimum ultimate inflation for the air mattress.

(6) Determining load of air mattress and optimum pressure level through look-up database based on time interval (step 15): The database of the optimum pressure can be any database obtained in advance through medical tests and associated calculation, and such database constitutes no novel parts of the present invention. Any currently available database can be used. The optimum pressure level obtained through the look-up database or other available database is set as the ultimate pressure for the air mattress.

(7) Charging air mattress to ultimate pressure level (step 16): The pressure of the air mattress is then regulated to achieve the ultimate pressure level.

Referring to FIG. 3, a structure of an air mattress controller in accordance with the present invention comprises the following constituent components:

A central processing unit (20) comprises a logic operation and control unit.

A servo unit (30) controls a pump (31) and a constant pressure valve (32) to charge air into the air mattress (not shown) and maintain a constant and stable pressure inside the air mattress. The servo unit (30) is controlled by the central processing unit (20).

A database (40) stores therein air mattress pressures associated with various body weights, ages, and names.

Referring to FIGS. 1 and 3, the central processing unit (20) instructs the servo unit (30) to control the pump (30) and the constant pressure valve (32) for charging air into the air mattress. The operation of charging air into the air mattress includes a first pressure, which is high, and a second pressure, which is low. By changing the internal pressure of the air mattress from the first pressure level to the second pressure level, the time interval that is needed to change from the first pressure to eventually obtain a stable condition of the second pressure level is calculated and used with the database (40) to determine the ultimate pressure level.

As described above, the present invention offers the following advantages:

(1) The controller of the present invention features an automatic regulation configuration, which offers ease, efficient and precise regulation as compared to manual adjustment.

(2) The automatic pressure regulation realized by the present invention is different from the conventional high-precision equipments, which are expensive, and is thus of low cost, and the regulation of pressure is automatically effected by determining the slope of the linear segments or the time interval, without entering the height, weight, age, and gender of the patient. All required data are automatically retrieved and human error can be eliminated, making the use more convenient.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A method for regulating air mattress pressure comprising the following steps:
(1) setting an initial first pressure;
(2) maintaining the first pressure stable with respect to an air mattress;
(3) setting a subsequent second pressure, wherein the second pressure is smaller than the first pressure;
(4) maintaining the second pressure stable with respect to the air mattress;
(5) computing a time interval for transferring from the first pressure to a stable condition of the second pressure;
(6) determining load and optimum pressure level of the air mattress through a database on the basis of the time interval; and
(7) charging air into the air mattress to the optimum pressure.

2. The method according to claim 1, wherein the time interval of steps (5) and (6) is obtained through a pressure-time curve.

3. The method according to claim 2, wherein the pressure-time curve includes an inclined line segment indicating the time interval.
